(19) United States
(12) Patent Application Publication
(10) Pub. No.: US 2012/0237735 A1
(43) Pub. Date: Sep. 20, 2012

(54) PRINTED ARTICLE AND METHOD OF MANUFACTURING PRINTED ARTICLE

(75) Inventor: Keigo SUGAI, Chino (JP)

(73) Assignee: SEIKO EPSON CORPORATION, Tokyo (JP)

(21) Appl. No.: 13/417,863

(22) Filed: Mar. 12, 2012

(30) Foreign Application Priority Data
Mar. 18, 2011 (JP) 2011-060428

(51) Int. Cl. B32B 3/28; B41J 2/015

(52) U.S. Cl. 428/162; 428/189; 347/20

(57) ABSTRACT

A molded article is obtained by carrying out a deforming process on a printed article including a base material, a light-blocking layer having light-blocking ability disposed on one side of the base material from which the molded article is intended to be viewed or on the other side of the base material opposite from the one side, and a light-blocking remediation layer having light-blocking ability disposed on the other side of the base material. The molded article includes a deformed section in which the base material has been stretched by carrying out the deforming process on the printed article. The light-blocking remediation layer is provided in a region of overlap of the deformed section and the light-blocking layer, when seen from the one side of the base material from which the molded article is intended to be viewed.

### CROSS-REFERENCE TO RELATED APPLICATIONS

This application claims priority to Japanese Patent Application No. 2011-060428 filed on Mar. 18, 2011. The entire disclosure of Japanese Patent Application No. 2011-060428 is hereby incorporated herein by reference.

### BACKGROUND

1. Technical Field

The present invention relates to a printed article and a method of manufacturing a printed article.

2. Related Art

Decorative plates (printed articles) for interior components of cars, exterior components of electronic devices, and the like have a base material, and a printed layer which has been printed with ink onto the base material; and in some instances may be provided with a light-blocking layer as the printed layer. Such decorative plates may be subjected to deforming processes involving localized stretching, such as drawing processes or bending processes, for example (for example, see Japanese Laid-Open Patent Application 2010-224302).

When a decorative plate is subjected to a deforming process, the thickness of the light-blocking layer is reduced in the stretched region thereof, and insufficient light-blocking ability may be a problem.

In order to address this issue, it would be conceivable, for example, to increase the thickness of the light-blocking layer in a manner commensurate with the expected reduction in thickness of the light-blocking layer when subjected to the deforming process; however, the light-blocking layer would be formed with unnecessary thickness in the non-stretched region, which is uneconomical.

In such cases, while it would be economical to increase the light-blocking layer thickness only in the vicinity of the region that will undergo stretching, with this method, asperity is formed on the surfaces of the region of increased thickness of the light-blocking layer, so the appearance of the decorative plate may be markedly diminished.

### SUMMARY

It is an object of the present invention to provide a printed article having ample light-blocking ability, without increased thickness of the light-blocking layer as a whole, and without forming asperity on the surface as seen from the direction in which the printed article is intended to be viewed; and a method of manufacturing a printed article.

The object is attained by the present invention described below.

A molded article according to one aspect of the present invention is obtained by carrying out a deforming process on a printed article including a base material, a light-blocking layer having light-blocking ability disposed on one side of the base material from which the molded article is intended to be viewed or on the other side of the base material opposite from the one side, and a light-blocking remediation layer having light-blocking ability disposed on the other side of the base material. The molded article includes a deformed section in which the base material has been stretched by carrying out the deforming process on the printed article. The light-blocking remediation layer is provided in a region of overlap of the deformed section and the light-blocking layer, when seen from the one side of the base material from which the molded article is intended to be viewed.

In so doing, there can be provided a molded article having ample light-blocking ability without increased thickness of the light-blocking layer as a whole, and without forming asperity on the surface as seen from the direction in which the molded article is intended to be viewed.

In the molded article according to the above described aspect of the present invention, the light-blocking layer is preferably provided to the one side of the base material.

In so doing, the light-blocking remediation layer is positioned on the back face side of the light-blocking layer as seen from the direction in which the molded article is intended to be viewed, and therefore the color of the light-blocking remediation layer need not be same as that of the light-blocking layer, thus affording greater latitude in design.

In the molded article according to the above described aspect of the present invention, the light-blocking layer is preferably provided to the other side of the base material, and the light-blocking remediation layer provided to the other side of the light-blocking layer which is the side opposite the side from which the molded article is intended to be viewed.

In so doing, the light-blocking remediation layer is positioned on the back face side of the light-blocking layer as seen from the direction in which the molded article is intended to be viewed, and therefore the color of the light-blocking remediation layer need not be same as that of the light-blocking layer, thus affording greater latitude in design. Additionally, because the light-blocking layer and the light-blocking remediation layer are positioned on the same side with respect to the base material, the light-blocking layer and the light-blocking remediation layer can be formed without flipping the base material.

In the molded article according to the above described aspect of the present invention, the light-blocking remediation layer is preferably provided to the other side of the base material, and the light-blocking layer is provided to the other side of the light-blocking remediation layer, which is the side opposite the side from which the molded article is intended to be viewed.

In so doing, the light-blocking layer and the light-blocking remediation layer are positioned on the same side with respect to the base material, and therefore the light-blocking layer and the light-blocking remediation layer can be formed without flipping the base material.

In the molded article according to the above described aspect of the present invention, the light-blocking layer and the light-blocking remediation layer are preferably positioned on the same side with respect to the base material.

In so doing, the light-blocking layer and the light-blocking remediation layer can be formed without flipping the base material.

In the molded article according to the above described aspect of the present invention, the light-blocking layer is preferably formed by ink for forming the light-blocking layer supplied through ejection in the form of liquid drops from nozzles by an inkjet method; and the light-blocking remediation layer is formed by ink for forming the light-blocking remediation layer supplied through ejection in the form of liquid drops from nozzles by an inkjet method.

In so doing, there can be provided a molded article having a light-blocking layer and a light-blocking remediation layer that have been accurately formed.

In the molded article according to the above described aspect of the present invention, the ink for forming the light-blocking layer and the ink for forming the light-blocking remediation layer are preferably respectively radiation curing inks; the light-blocking layer is a layer in which ink for forming the light-blocking layer is supplied through ejection in the form of liquid drops from nozzles by an inkjet method then cured through irradiation with radiation; and the light-blocking remediation layer is a layer in which ink for forming the light-blocking remediation layer is supplied through ejection in the form of liquid drops from nozzles by an inkjet method and then cured through irradiation with radiation.

In so doing, there can be provided a molded article having a light-blocking layer and a light-blocking remediation layer that have been accurately formed.

A method of manufacturing a molded article according to another aspect of the present invention includes: forming the printed article, and carrying out the deforming process on the printed article. The forming of the printed article includes forming a light-blocking layer having light-blocking ability on one side of a base material or on the other side of the base material, and forming a light-blocking remediation layer having light-blocking ability in a region on the other side of the base material so that the light-blocking layer and a deformed section constituted by a region in which the base material is stretched by carrying out the deforming process overlap when seen from the side from which the printed article is intended to be viewed.

In so doing, the molded article of the present invention can be readily manufactured in a reliable fashion.

A method of manufacturing a printed article according to another aspect of the present invention includes: forming a light-blocking layer having light-blocking ability on one side of a base material or on the other side of the base material; and forming a light-blocking remediation layer having light-blocking ability in a region on the other side of the base material so that the light-blocking layer and a deformed section constituted by a region in which the base material is stretched by carrying out the deforming process overlap when seen from the side from which the printed article is intended to be viewed. In so doing, the printed article of the present invention can be readily manufactured in a reliable fashion.

### BRIEF DESCRIPTION OF THE DRAWINGS

Referring now to the attached drawings which form a part of this original disclosure:

FIGS. 1A and 1B are cross sectional views showing a first embodiment of the printed article of the present invention;

FIG. 2 is a perspective view showing a schematic configuration of a printing device employed in manufacturing the printed article of the present invention;

FIG. 3 is a side sectional view showing a schematic configuration of a carriage of the printing device shown in FIG. 2;

FIG. 4 is a bottom view showing the schematic configuration of the carriage of the printing device shown in FIG. 2;

FIGS. 5A to 5C are schematic configuration views of a liquid drop ejection head;

FIGS. 6A and 6B are cross sectional views showing a second embodiment of the printed article of the present invention; and

FIGS. 7A and 7B are cross sectional views showing a third embodiment of the printed article of the present invention.

### DETAILED DESCRIPTION OF EXEMPLARY EMBODIMENTS

The printed article and method of manufacturing a printed article of the present invention are described in detail below on the basis of the presently preferred embodiments with reference to the accompanying drawings.

### First Embodiment

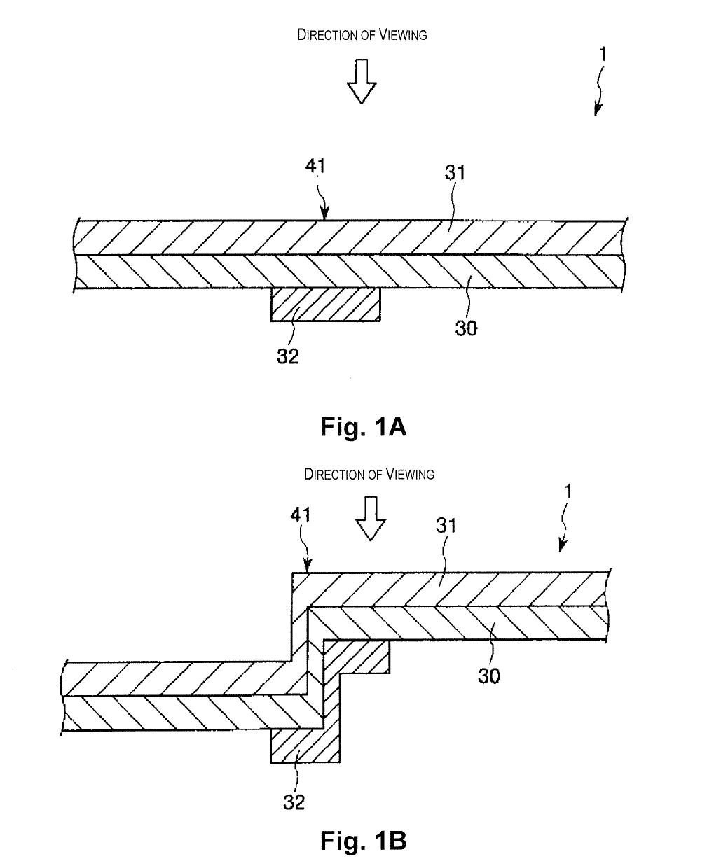

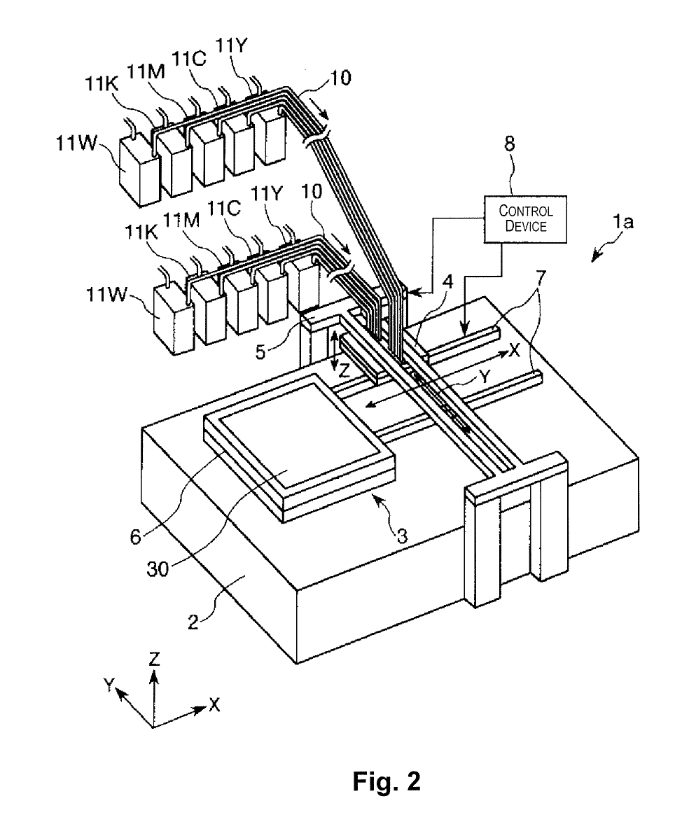

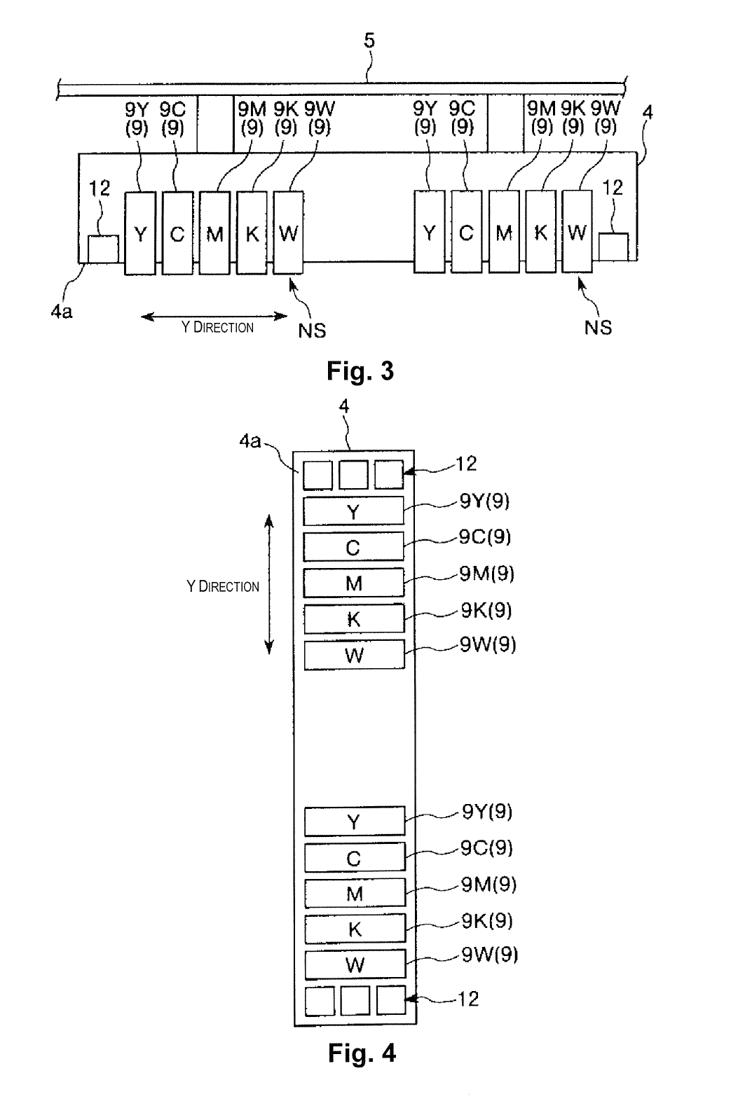

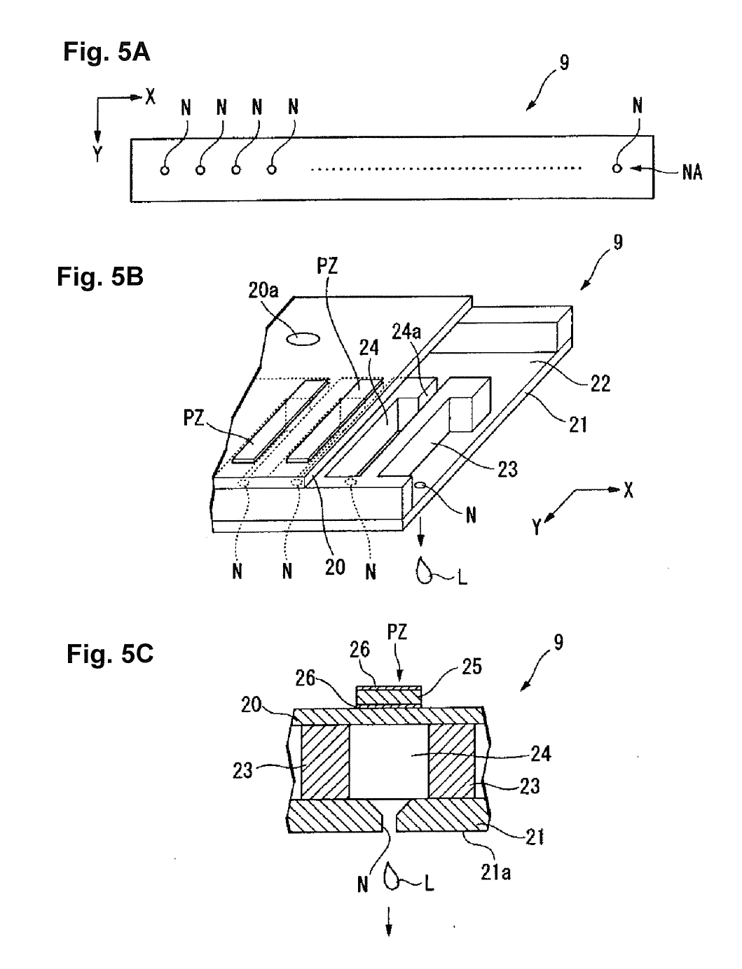

FIG. 1 is a cross sectional view showing a first embodiment of the printed article of the present invention; FIG. 2 is a perspective view showing a schematic configuration of a printing device employed in manufacturing the printed article of the present invention; FIG. 3 is a side sectional view showing a schematic configuration of a carriage of the printing device shown in FIG. 2; FIG. 4 is a bottom view showing the schematic configuration of the carriage of the printing device shown in FIG. 2; and FIG. 5 is a schematic configuration view of a liquid drop ejection head.

In the following description, the left side in FIG. 1 shall be designated as “left,” the right side as “right,” the top side as “top,” and the bottom side as “bottom.”

As shown in FIG. 1, a printed article 1 has a base material (substrate) 30; a light-blocking layer 31 provided to one surface of the base material 30; and a light-blocking remediation layer 32 having light-blocking ability, provided to the back surface of the base material 30 as seen from the direction in which the printed article 1 is intended to be viewed. The base material 30 has a deformed section 41 stretched by a deforming process, and the light-blocking remediation layer 32 is provided in a region which includes the deformed section 41.

First, a first ink and a second ink, i.e., an ink set, employed as the ink for forming the light-blocking layer and the ink for forming the light-blocking remediation layer will be described.

### Ink Set

The ink set that can be employed for manufacture of the printed article 1, i.e., for printing, is not particularly limited, but is provided with a first ink which is a radiation curing ink containing (a-1) a polymerization initiator and (b-1) a polymerizable compound; and a second ink which is a radiation curing ink containing (a-2) a polymerization initiator and (b-2) a polymerizable compound. The first ink is an ink for forming a light-blocking layer employed to form (print) the light-blocking layer 31, and an ink for forming a light-blocking remediation layer employed to form the light-blocking remediation layer 32. Of the total mass of the (b-1) polymerizable compound, it is preferable for a monofunctional polymerizable compound to constitute 65 mass % or more. In the second ink, of the total mass of the (b-2) polymerizable compound, it is preferable for a polyfunctional polymerizable compound to constitute 50 mass % or more. The ink for forming the light-blocking layer and the ink for forming the light-blocking remediation layer may be the same or different. Herein, in cases where there is no need to distinguish between the first ink and the second ink, they shall be termed simply “ink” or “radiation curing ink.”

An ink set for inkjet recording applications is suitable for use as the aforedescribed ink set.

The radiation curing ink needs to be one that cures at high sensitivity so as to form an image of high image quality.

High sensitivity of the ink imparts high curability in response to irradiation with activating radiation, and therefore confers a number of advantages such as reduced power consumption, and longer service life of the activating radiation generating device due to reduced load; as well as minimizing volatilization of uncured low-molecular weight substances and diminished strength of the formed image. Moreover, the ink needs to have ample scratch resistance and flexibility of the cured film, in order for the image (printed article) obtained thereby to be resistant to cracking, peeling, and the like. Cured films having flexibility and scratch resistance have the merits of being able to be displayed or stored while maintaining high image quality of the printed article for extended periods in various environments, and of ready handling of the printed article.

The first ink contains (a-1) a polymerization initiator and (b-1) a polymerizable compound, and in preferred practice, of the total mass of the (b-1) polymerizable compound, is a monofunctional polymerizable compound (herein also termed a “monofunctional monomer”) constitutes 65 mass % or more.

The second ink contains (a-2) a polymerization initiator and (b-2) a polymerizable compound, and in preferred practice, of the total mass of the (b-2) polymerizable compound a polyfunctional polymerizable compound (herein also termed a “polyfunctional monomer”) constitutes 50 mass % or more.

In the inks, the mass ratio of the monofunctional polymerizable compound to the total mass of polymerizable compound in the ink is also referred to as the “monofunctional monomer ratio”; and the mass ratio of the polyfunctional polymerizable compound to the total mass of polymerizable compound in the ink is also referred to as the “polyfunctional monomer ratio.” The monofunctional monomer ratio (%) and the polyfunctional monomer ratio (%) are rounded off to the closest whole number.

The inks are radiation curing inks curable through irradiation with activating radiation.

The aforedescribed “activating radiation” is not limited in any particular way provided that the activating radiation is one that can impart energy able to generate initiating species in the ink during irradiation therewith, and broadly includes alpha rays, gamma rays, X-rays, ultraviolet (UV), visible light, electron beams, and the like; however, among these, ultraviolet and electron beams, and ultraviolet in particular, are preferred from the standpoint of curing sensitivity and ease of procuring equipment. Consequently, it is preferable for the inks to be inks that are curable by irradiation with ultraviolet.

In the present embodiment, when the light-blocking layer 31 and the light-blocking remediation layer 32 which are formed by the first ink, i.e., by the ink for forming the light-blocking layer and the ink for forming the light-blocking remediation layer, are compared with the printed layer, not shown, which is formed by the second ink, the light-blocking layer 31 and the light-blocking remediation layer 32 are respectively more stretchable under heating than is the printed layer, whereas the printed layer has a higher elastic modulus than the light-blocking layer 31 and the light-blocking remediation layer 32. Consequently, it is preferable for the first ink to be employed in regions that will undergo deformation processes, and for the second ink to be employed in regions that will undergo shearing processes or be subjected to pressure associated with mounting or the like.

The components of the inks are described below.

### (A) Polymerization Initiator

Known radical polymerization initiators and known cationic polymerization initiator can be used as polymerization initiators. A single polymerization initiator may be used, or two or more used concomitantly. Radical polymerization initiators and cationic polymerization initiators may be used concomitantly as well.

A polymerization initiator is a compound that absorbs outside energy and generates a polymerization initiating species. The outside energy used in order to initiate polymerization can be broadly distinguished as being heat or activating radiation, with which thermal polymerization initiators and photopolymerization initiators, respectively, would be used. Examples of activating radiation are gamma rays, beta rays, electron beams, ultraviolet, visible light, and infrared.

In cases in which a radical polymerizable compound is used as the polymerizing compound, the ink will preferably contain a radical polymerization initiator; or in cases in which a cationic polymerizable compound is used as the polymerizing compound, will preferably contain a cationic polymerization initiator.

### Radical Polymerization Initiators

Examples of radical polymerization initiators include aromatic ketones, acylphosphine compounds, aromatic onium salt compounds, organic peroxides, thio compounds, hexaarylbiimidazole compounds, ketoxime ester compounds, borate compounds, azinium compounds, metallocene compounds, active ester compounds, compounds having a carbon-halogen bond, alkylamine compounds, and the like. For these radical polymerization initiators, the aforedescribed compounds may be used singly or in combination. Radical polymerization initiators may used singly or in combinations of two or more.

### Cationic Polymerization Initiators

Examples of cationic polymerization initiators (photo-acid generators) include chemically amplified photoresists and compounds used in cationic photopolymerization (“Imejingu you Yukizairyou” [Organic Materials for Imaging], Ed. The Japanese Research Association for Organic Electronics Materials, Bunshin Publishing Co. (1993), pp. 187-192).

Firstly, B(C₆F₅)₄⁻, PF6⁻, AsF₆⁻, SbF₆⁻, and CF₃SO₃⁻ salts of diazonium, ammonium, iodonium, sulfonium, phosphonium, and other aromatic onium compounds can be cited. Secondly, sulfonates that generate sulfonic acid can be cited. Thirdly, halides that photogenerate a hydrogen halide can also be employed. Fourthly, iron arene complexes can be cited.

In the inks, the respective total amount of polymerization initiator used is 0.01 to 35 mass %, more preferably 0.5 to 20 mass %, and still more preferably 1.0 to 20 mass %, with respect to the total amount of polymerizable compound used. With 0.1 mass % or above, the ink can be sufficiently cured; and with 35 wt % or less, a cured film having a uniform degree of curing can be obtained.

Additionally, when a sensitizer, to be described later, is employed in the ink, the total amount of polymerization initiator used, expressed as the mass ratio of the polymerization initiator to the sensitizer, is preferably such that the polymerization initiator:sensitizer ratio is 200:1 to 1:200, more preferably 50:1 to 1:50, and still more preferably 20:1 to 1:5.

### (B) Polymerizable Compound

The inks contain a polymerizable compound.

The polymerizable compound preferably has a molecular weight of no greater than 1,000, more preferably 50 to 800, and yet more preferably 60 to 500.

The polymerizable compound is not particularly limited, and may be any compound that, when imparted with energy of some sort, gives rise to a polymerization reaction such as a radical polymerization reaction, a cationic polymerization reaction, or an anionic polymerization reaction, to bring about curing. Monomers, oligomers, and polymers of any kind may be used, and various types of known polymerizable monomers, known as photopolymerizable compounds, which give rise to a polymerization reaction by an initiating species generated from the polymerization initiator, can be used.

Examples of preferred polymerizable compounds are radical polymerizable compound and cationic polymerizable compounds.

### Radical Polymerizable Compounds

The radically polymerizable compound is not particularly limited, and known radically polymerizable compounds may be employed. An ethylenically unsaturated compound is preferred, a (meth)acrylate compound; a (meth)acrylamide compound, an N-vinyl compound, and/or a vinyl ether compound is more preferred; and a (meth)acrylate compound and/or an N-vinyl compound is still more preferred. Herein, “(meth)acrylic” signifies both acrylic and methacrylic.

In cases in which a radically polymerizable compound is used in the first ink, of the total mass of the (b-1) polymerizable compound in the first ink, a monofunctional radically polymerizable compound preferably constitutes 67 to 100 mass %, more preferably 70 to 100 mass %, and still more preferably 85 to 95 mass %. Within the above ranges, the images obtained have excellent flexibility.

In cases in which a radically polymerizable compound is used in the second ink, of the total mass of the (b-2) polymerizable compound in the second ink, a polyfunctional radically polymerizable compound preferably constitutes 55 to 100 mass %, more preferably 60 to 100 mass %, and still more preferably 80 to 100 mass %. It is especially preferable for 100 mass %, i.e., all of the (b-2) polymerizable compound, to be a polyfunctional radically polymerizable compound. Within the above ranges, the images obtained have excellent scratch resistance and solvent resistance.

The radically polymerizable compound may be monofunctional or polyfunctional.

As monofunctional radically polymerizable compounds, an N-vinyl compound, to be described later, is preferred, and an N-vinyl lactam is more preferred.

Furthermore, in cases in which a radically polymerizable compound is used as the (b-1) polymerizable compound in the first ink, the first ink preferably contains an N-vinyl compound, to be described later, and particularly preferably contains an N-vinyl lactam.

As polyfunctional radically polymerizable compounds, a polyfunctional (meth)acrylate compound, to be described later, is preferred. Herein, “(meth)acrylic” signifies both acrylic and methacrylic.

As polyfunctional radically polymerizable compounds, the use in combination of a difunctional radically polymerizable compound and a tri- or higher-functional radically polymerizable compound is preferred; and the use in combination of a difunctional radically polymerizable compound and a trifunctional radically polymerizable compound is more preferred.

In cases in which a radically polymerizable compound is used as the (b-2) polymerizable compound in the second ink, of the total mass of the (b-2) polymerizable compound in the second ink, a difunctional radically polymerizable compound preferably constitutes 30 to 100 mass %, more preferably 50 to 95 mass %, and still more preferably 70 to 90 mass %. Of the total mass of the (b-2) polymerizable compound in the second ink, a tri- or higher-functional radically polymerizable compound preferably constitutes 5 to 50 mass %, and more preferably 10 to 30 mass %. Of the total mass of the (b-2) polymerizable compound in the second ink, a trifunctional radically polymerizable compound preferably constitutes 5 to 50 mass %, and more preferably 10 to 30 mass %.

In cases in which a radically polymerizable compound is used in the first ink, of the total mass of the first ink, a monofunctional radically polymerizable compound preferably constitutes 50 to 95 mass %, more preferably 55 to 90 mass %, and still more preferably 60 to 85 mass % of the first ink. Within the above ranges, the images obtained have excellent flexibility.

In cases in which a radically polymerizable compound is used in the second ink, of the total mass of the second ink, a polyfunctional radically polymerizable compound preferably constitutes 50 to 98 mass %, more preferably 55 to 95 mass %, and still more preferably 60 to 90 mass % of the second ink. Within the above ranges, the images obtained have excellent scratch resistance and solvent resistance.

Monofunctional radically polymerizable compounds and polyfunctional radically polymerizable compounds are explained below.

### Monofunctional Radically Polymerizable Monomer

A monofunctional radically polymerizable monomer may be used as the radically polymerizable compound.

Preferred examples of monofunctional radically polymerizable monomers include monofunctional acrylate compounds, monofunctional methacrylates, monofunctional N-vinyl compounds, monofunctional acrylamide compounds, and monofunctional methacrylamide compounds, with monofunctional acrylate compounds, monofunctional methacrylate compounds, and monofunctional N-vinyl compounds being more preferred.

In cases in which the first ink contains a monofunctional radically polymerizable monomer, as the monofunctional radically polymerizable monomer it is preferable to concomitantly use a monofunctional acrylate compound and a monofunctional N-vinyl compound, or a monofunctional methacrylate compound and a monofunctional N-vinyl compound; concomitant use of a monofunctional acrylate compound and a monofunctional N-vinyl compound is especially preferred.

As monofunctional radically polymerizable monomers, it is preferable to use a monomer having a cyclic structure and only one ethylenically unsaturated double bond group selected from the group consisting of an acryloyloxy group, a methacryloyloxy group, an acrylamide group, a methacrylamide group, and an N-vinyl group.

Ethylenically unsaturated compounds may be cited as radically polymerizable monomers that can be suitably used.

As preferred examples of monofunctional acrylates, monofunctional methacrylates, monofunctional vinyloxy compounds, monofunctional acrylamides, and monofunctional methacrylamides, there may be cited monofunctional radically polymerizable monomers having a group with a cyclic structure, such as a phenyl group, a naphthyl group, an anthracenyl group, a pyridinyl group, a tetrahydrofurfuryl group, a piperidinyl group, a cyclohexyl group, a cyclopentyl group, a cycloheptyl group, an isoboronyl group, or a tricyclodecanyl group.

Preferred examples of monofunctional radically polymerizable monomers include norbornyl (meth)acrylate, isoboronyl (meth)acrylate, cyclohexyl (meth)acrylate, cyclopentyl (meth)acrylate, cycloheptyl (meth)acrylate, cyclooctyl (meth)acrylate, cyclodecyl (meth)acrylate, dicyclodecyl (meth)acrylate, trimethylcyclohexy (meth)acrylate, 4-t-butylcyclohexyl (meth)acrylate, acryloylmorpholine, 2-benzyl (meth)acrylate, phenoxyethyl (meth)acrylate, phenoxydiethylene glycol (meth)acrylate, phenoxytriethylene glycol (meth)acrylate, EO-modified cresol (meth)acrylate, tetrahydrofurfuryl (meth)acrylate, caprolactone-modified tetrahydrofurfuryl acrylate, nonylphenoxy polyethylene glycol (meth)acrylate, neopentyl glycol benzoate (meth)acrylate, paracumylphenoxyethylene glycol (meth)acrylate, N-phthalimidoethyl (meth)acrylate, pentamethylpiperidyl (meth)acrylate, tetramethylpiperidyl (meth)acrylate, N-cyclohexyl acrylamide, N-(1,1-dimethyl-2-phenyl)ethyl acrylamide, N-diphenylmethyl acrylamide, N-phthalimidomethyl acrylamide, N-(1,1′-dimethyl-3-(1,2,4-triazol-1-yl))propyl acrylamide, and 5-(meth)acryloyloxymethyl-5-ethyl-1,3-dioxacyclohexane.

As the monofunctional radically polymerizable monomer, it is preferable to use a radically polymerizable monomer having an N-vinyl group, and a group having a cyclic structure. Of these, it is preferable to use N-vinylcarbazole, 1-vinylimidazole, or N-vinyl lactams, and still more preferable to use N-vinyl lactams.

The first ink preferably contains a monofunctional cyclic polymerizable monomer having an N-vinyl group, in an amount of 1 to 40 mass %, more preferably 10 to 35 wt %, and still more preferably 12 to 30 wt %, of the entire first ink. Within the above ranges, copolymerizability with other polymerizable compounds is good, and an ink having excellent curability and anti-blocking properties is obtained.

The first ink preferably contains a monofunctional N-vinyl lactam in an amount of 1 to 40 mass %, more preferably 10 to 35 wt %, and still more preferably 12 to 30 wt %, of the entire first ink.

Where the amount of monofunctional N-vinyl lactams used is in the aforedescribed numerical ranges, curability, cured film flexibility, and cured film adhesion to a support are excellent. N-vinyl lactams are compounds having a relatively high melting point. Where the content of N-vinyl lactams is 40 mass % or less, solubility is good even at low temperatures of 0° C. or below, affording a wider temperature range in which the ink composition may be handled.

As monofunctional radically polymerizable monomers, acyclic monofunctional monomers such as the following may be used. Acyclic monofunctional monomers have relatively low viscosity and are preferable for use, for example, for the purpose of lowering the viscosity of the ink. However, from the viewpoint of minimizing tackiness of the cured coating and imparting high film strength so that scratches, etc., do not occur during molding processes, the proportion of the following acyclic monofunctional monomers in the total ink is preferably 20 mass % or less, more preferably 15 mass % or less.

Specific examples include octyl (meth)acrylate, 2-ethylhexyl (meth)acrylate, decyl (meth)acrylate, dodecyl (meth)acrylate, tridecyl (meth)acrylate, tetradecyl (meth)acrylate, hexadecyl (meth)acrylate, 2-hydroxyethyl (meth)acrylate, butoxyethyl (meth)acrylate, carbitol (meth)acrylate, 2-ethylhexyl diglycol (meth)acrylate, polyethylene glycol (meth)acrylate monomethyl ether, polypropylene glycol (meth)acrylate monomethyl ether, and polytetraethylene glycol (meth)acrylate monomethyl ether.

Other examples besides these include (poly)ethylene glycol mono(meth)acrylate, (poly)ethylene glycol (meth)acrylate methyl ester, (poly)ethylene glycol (meth)acrylate ethyl ester, (poly)ethylene glycol (meth)acrylate phenyl ester, (poly)propylene glycol mono(meth)acrylate, (poly)ethylene glycol mono(meth)acrylate phenyl ester, (poly)propylene glycol (meth)acrylate methyl ester, (poly)propylene glycol (meth)acrylate ethyl ester, 2-ethylhexyl acrylate, n-octyl acrylate, n-nonyl acrylate, n-decyl acrylate, isooctyl acrylate, n-lauryl acrylate, n-tridecyl acrylate, n-cetyl acrylate, n-stearyl acrylate, 2-hydroxyethyl acrylate, butoxyethyl acrylate, tetrahydrofurfuryl acrylate, benzyl acrylate, oligoester acrylate, N-methylolacrylamide, diacetone acrylamide, epoxy acrylate, methyl methacrylate, n-butyl methacrylate, 2-ethylhexyl methacrylate, n-octyl methacrylate, n-nonyl methacrylate, n-decyl methacrylate, isooctyl methacrylate, n-lauryl methacrylate, n-tridecyl methacrylate, n-cetyl methacrylate, n-stearyl methacrylate, allyl methacrylate, glycidyl methacrylate, benzyl methacrylate, dimethylaminomethyl methacrylate, and allyl glycidyl ether.

Further examples include 2-ethylhexyl-diglycol acrylate, 2-hydroxy-3-phenoxylpropyl acrylate, 2-hydroxybutyl acrylate, 2-acryloyloxyethylphthalic acid, 2-acryloyloxyethyl-2-hydroxyethylphthalic acid, ethoxylated phenyl acrylate, 2-acryloyloxyethylsuccinic acid, 2-acryloyloxyethylhexahydrophthalic acid, lactone-modified flexible acrylate, butoxyethyl acrylate, 2-hydroxyethyl acrylate, and methoxydipropylene glycol acrylate.

### Polyfunctional Radically Polymerizable Monomers

Polyfunctional radically polymerizable monomers may be used as the radically polymerizable compound.

Examples of preferred polyfunctional radically polymerizable monomers include polyfunctional polymerizable monomers having two or more ethylenically unsaturated double bonds selected from the group consisting of an acryloyloxy group, a methacryloyloxy group, an acrylamide group, a methacrylamide group, a vinyloxy group, and an N-vinyl group. By virtue of containing a polyfunctional polymerizable monomer, an ink having high cured coating strength is obtained.

Examples of polyfunctional polymerizable monomers having a radically polymerizable ethylenically unsaturated bond preferred for employment herein include unsaturated carboxylic acids such as acrylic acid, methacrylic acid, itaconic acid, crotonic acid, isocrotonic acid, and maleic acid, and salts thereof; anhydrides having an ethylenically unsaturated group; acrylonitrile; styrene; and various types of unsaturated polyesters; unsaturated polyethers; unsaturated polyamides; and (meth)acrylic acid esters of unsaturated urethane (meth)acrylic monomers or prepolymers, epoxy monomers or prepolymers, or urethane monomers or prepolymers, which compounds have two or more ethylenically unsaturated double bonds.

As specific examples, there may cited neopentyl glycol di(meth)acrylate, (poly)ethylene glycol di(meth)acrylate, diethylene glycol di(meth)acrylate, triethylene glycol di(meth)acrylate, tetraethylene glycol di(meth)acrylate, polypropylene glycol di(meth)acrylate, (poly)tetramethylene glycol di(meth)acrylate, bisphenol A propylene oxide (PO) adduct di(meth)acrylate, ethoxylated neopentyl glycol di(meth)acrylate, propoxylated neopentyl glycol di(meth)acrylate, bisphenol A ethylene oxide (EO) adduct di(meth)acrylate, EO-modified pentaerythritol tri(meth)acrylate, PO-modified pentaerythritol tri(meth)acrylate, EO-modified pentaerythritol tetra(meth)acrylate, PO-modified pentaerythritol tetra(meth)acrylate, EO-modified dipentaerythritol tetra(meth)acrylate, PO-modified dipentaerythritol tetra(meth)acrylate, EO-modified trimethylolpropane tri(meth)acrylate, PO-modified trimethylolpropane tri(meth)acrylate, EO-modified tetramethylolmethane tetra(meth)acrylate, PO-modified tetramethylolmethane tetra(meth)acrylate, pentaerythritol tri(meth)acrylate, pentaerythritol tetra(meth)acrylate, dipentaerythritol tetra(meth)acrylate, trimethylolpropane tri(meth)acrylate, tetramethylolmethane tetra(meth)acrylate, trimethylolethane tri(meth)acrylate, trimethylolpropane tri(meth)acrylate, bis(4-(meth)acryloxypolyethoxyphenyl)propane, diallyl phthalate, triallyl trimellitate, 1,6-hexanediol di(meth)acrylate, 1,9-nonanediol di(meth)acrylate, 1,10-decanediol di(meth)acrylate, neopentyl glycol hydroxypivalate di(meth)acrylate, tetramethylolmethane tri(meth)acrylate, dimethyloltricyclodecane di(meth)acrylate, modified glycerol tri(meth)acrylate, bisphenol A diglycidyl ether (meth)acrylic acid adduct, modified bisphenol A di(meth)acrylate, caprolactone-modified dipentaerythritol hexa(meth)acrylate, dipentaerythritol hexa(meth)acrylate, pentaerythritol tri(meth)acrylate tolylene diisocyanate urethane prepolymer, pentaerythritol tri(meth)acrylate hexamethylene diisocyanate urethane prepolymer, ditrimethylolpropane tetra(meth)acrylate, and pentaerythritol tri(meth)acrylate hexamethylene diisocyanate urethane prepolymer. In more specific terms, commercial products, or radically polymerizable/crosslinking monomers, oligomers, and polymers known in the industry, such as those described in “Kakyozai Handobukku” [Crosslinking Agent Handbook], Ed. S. Yamashita (Taiseisha, 1981); in “UVEB Koka Handobukku (Genryo)” [UVEB Curing Handbook (Starting Materials)] Ed. K. Kato (Kobunshi Kankoukai, 1985); in “UVEB Koka Gijutsu no Oyo to Shijyo” [Applications and Markets for UVEB Curing Technology], p. 79, Ed. Rad Tech (CMC, 1989); and E. Takiyama “Poriesuteru Jushi Handobukku” [Polyester Resin Handbook], (The Nikkan Kogyo Shimbun Ltd., 1988) may be employed.

Among these, the following polyfunctional polymerizable monomers can be cited as preferred examples.

As preferred examples of difunctional radically polymerizable monomers, there can be cited ethylene glycol di(meth)acrylate, diethylene glycol di(meth)acrylate, triethylene glycol di(meth)acrylate, tetraethylene glycol di(meth)acrylate, polyethylene glycol di(meth)acrylate, propylene glycol di(meth)acrylate, dipropylene glycol di(meth)acrylate, tripropylene glycol di(meth)acrylate, tetrapropylene glycol di(meth)acrylate, polypropylene glycol di(meth)acrylate, ethoxylated neopentyl glycol diacrylate, and propoxylated neopentyl glycol diacrylate.

Further, it is preferable to employ a vinyl ether compound as the radically polymerizable compound.

The monomers cited above as examples of the radically polymerizable compounds have high reactivity, low viscosity, and excellent adhesion to a support.

### Cationically Polymerizable Compounds

From the standpoint of curability and abrasion resistance, oxetane ring-containing compounds and oxirane ring-containing compounds are suitable cationically polymerizable compounds; a mode in which both an oxetane ring-containing compound and an oxirane ring-containing compound are contained is preferred.

Here, an oxirane ring-containing compound (also termed “an oxirane compound” herein) refers to a compound including at least one oxirane ring (an oxiranyl group or epoxy group) in the molecule; and in more specific terms may be one selected appropriately from those commonly used as epoxy resins, for example, conventional known aromatic epoxy resins, alicyclic epoxy resins, and aliphatic epoxy resins. Monomers, oligomers, and polymers are all acceptable.

An oxetane ring-containing compound (also called an “oxetane compound” herein) refers to a compound including at least one oxetane ring (oxetanyl group) in the molecule.

In cases in which a cationically polymerizable compound is used in the first ink, of the total mass of the (b-1) polymerizable compound, the monofunctional cationically polymerizable compound preferably constitutes 65 to 95 mass %, more preferably 65 to 85 mass %, and still more preferably 65 to 75 mass %. Within the above-mentioned ranges, the images obtained have excellent flexibility.

In cases in which a cationically polymerizable compound is used in the second ink, of the total mass of the (b-2) polymerizable compound, the polyfunctional cationically polymerizable compound preferably constitutes 50 to 90 mass %, more preferably 52 to 75mass %, and still more preferably 55 to 65 mass %. Within the above-mentioned ranges, the images obtained have scratch resistance and solvent resistance.

The cationically polymerizable compound may be monofunctional or polyfunctional.

A monofunctional oxirane compound and/or a monofunctional oxetane compound are preferred monofunctional cationically polymerizable compounds.

A difunctional cationically polymerizable compound is a preferred polyfunctional cationically polymerizable compound. The polyfunctional cationically polymerizable compound is preferably a polyfunctional oxirane compound and/or a polyfunctional oxetane compound, with concomitant use of a polyfunctional oxirane compound and a polyfunctional oxetane compound being more preferable.

In cases in which a cationically polymerizable compound is used in the first ink, of the total mass of the first ink, the monofunctional cationically polymerizable compound preferably constitutes 40 to 95 mass %, more preferably 45 to 80 mass %, and still more preferably 45 to 65 mass %, of the first ink. Within the above-mentioned ranges, the images obtained have excellent flexibility.

In cases in which a cationically polymerizable compound is used in the second ink, of the total mass of the second ink, the polyfunctional cationically polymerizable compound preferably constitutes 35 to 90 mass %, more preferably 38 to 75 mass %, and still more preferably 40 to 60 mass %, of the second ink. Within the above-mentioned ranges, the images obtained have scratch resistance and solvent resistance.

Monofunctional cationically polymerizable compounds and polyfunctional cationically polymerizable compounds are described in detail below.

Examples of cationically polymerizable compounds include, for example, the epoxy compounds, vinyl ether compounds, and oxetane compounds disclosed inter alia in JP-A-6-9714, JP-A-2001-31892, JP-A-2001-40068, JP-A-2001-55507, JP-A-2001-310938, JP-A-2001-310937, JP-A-2001-220526.

As examples of monofunctional epoxy compounds, there may be cited, for example, phenyl glycidyl ether, p-tert-butylphenyl glycidyl ether, butyl glycidyl ether, 2-ethylhexyl glycidyl ether, allyl glycidyl ether, 1,2-butylene oxide, 1,3-butadiene monooxide, 1,2-epoxydodecane, epichlorohydrin, 1,2-epoxydecane, styrene oxide, cyclohexene oxide, 3-methacryloyloxymethylcyclohexene, oxide, 3-acryloyloxymethylcyclohexene oxide, 3-vinylcyclohexene oxide, and the like.

As examples of polyfunctional epoxy compounds, there may be cited, for example, bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, epoxy novolac resins, hydrogenated bisphenol A diglycidyl ether, hydrogenated bisphenol F diglycidyl ether, hydrogenated bisphenol S diglycidyl ether, 3,4-epoxycyclohexylmethyl-3′,4′-epoxycyclohexane carboxylate, 2-(3,4-epoxycyclohexyl)-7,8-epoxy-1,3-dioxaspiro[5.5]undecane, bis(3,4-epoxycyclohexylmethyl) adipate, vinylcyclohexene oxide, 4-vinylepoxycyclohexane, bis(3,4-epoxy-6-methylcyclohexylmethyl)adipate, 3,4-epoxy-6-methylcyclohexyl-3′,4′-epoxy-6′-methylcyclohexane carboxylate, methylenebis(3,4-epoxycyclohexane), dicyclopentadiene diepoxide, the di(3,4-epoxycyclohexylmethyl) ether of ethylene glycol, ethylenebis(3,4-epoxycyclohexanecarboxylate), dioctyl epoxyhexahydrophthalate, di-2-ethylhexyl epoxyhexahydrophthalate, 1,4-butanediol diglycidyl ether, 1,6-hexanediol diglycidyl ether, glycerol triglycidyl ether, trimethylolpropane triglycidyl ether, polyethylene glycol diglycidyl ether, polypropylene glycol diglycidyl ethers, 1,13-tetradecadiene dioxide, limonene dioxide, 1,2,7,8-diepoxyoctane, 1,2,5,6-diepoxycyclooctane, and the like.

Of these epoxy compounds, aromatic epoxides and alicyclic epoxides are preferable from the standpoint of excellent curing speed, with alicyclic epoxides being particularly preferred.

As vinyl ether compounds, di- or tri-vinyl ether compounds are preferable from the standpoint of curability, adhesion to a support, and surface hardness of the image formed. Divinyl ether compounds are particularly preferred.

The oxetane compound used may be selected from among any of the known oxetane compounds, such as those disclosed in JP-A-2001-220526, JP-A-2001-310937, and JP-A-2003-341217.

As the oxetane compound, a compound having 1 to 4 oxetane rings in the structure is preferable. Through the use of such a compound, the viscosity of the inkjet recording liquid is readily maintained in a range affording good handling properties; moreover, an ink that, when cured, has high adhesion to a support can be obtained.

As examples of monofunctional oxetane compounds, there may be cited, for example, 3-ethyl-3-hydroxymethyloxetane, 3-(meth)allyloxymethyl-3-ethyloxetane, (3-ethyl-3-oxetanylmethoxy)methylbenzene, 4-fluoro-[1-(3-ethyl-3-oxetanylmethoxy)methyl]benzene, 4-methoxy-[1-(3-ethyl-3-oxetanylmethoxy)methyl]benzene, [1-(3-ethyl-3-oxetanylmethoxy)ethyl]phenyl ether, isobutoxymethyl(3-ethyl-3-oxetanylmethyl) ether, isobornyloxyethyl(3-ethyl-3-oxetanylmethyl) ether, isobornyl(3-ethyl-3-oxetanylmethyl) ether, 2-ethylhexyl(3-ethyl-3-oxetanylmethyl) ether, ethyl diethylene glycol(3-ethyl-3-oxetanylmethyl) ether, dicyclopentadiene(3-ethyl-3-oxetanylmethyl) ether, dicyclopentenyloxyethyl(3-ethyl-3-oxetanylmethyl) ether, dicyclopentenyl(3-ethyl-3-oxetanylmethyl) ether, tetrahydrofurfuryl(3-ethyl-3-oxetanylmethyl) ether, tetrabromophenyl(3-ethyl-3-oxetanylmethyl) ether, 2-tetrabromophenoxyethyl(3-ethyl-3-oxetanylmethyl) ether, tribromophenyl(3-ethyl-3-oxetanylmethyl) ether, 2-tribromophenoxyethyl(3-ethyl-3-oxetanylmethyl) ether, 2-hydroxyethyl(3-ethyl-3-oxetanylmethyl) ether, 2-hydroxypropyl(3-ethyl-3-oxetanylmethyl) ether, butoxyethyl(3-ethyl-3-oxetanylmethyl) ether, pentachlorophenyl(3-ethyl-3-oxetanylmethyl) ether, pentabromophenyl(3-ethyl-3-oxetanylmethyl) ether, bomyl(3-ethyl-3-oxetanylmethyl) ether, and the like.

As examples of polyfunctional oxetane compounds, there may be cited, for example, 3,7-bis(3-oxetanyl)-5-oxanonane, 3,3′-(1,3-(2-methylenyl)propanediylbis(oxymethylene))bis(3-ethyloxetane), 1,4-bis[(3-ethyl-3-oxetanylmethoxy)methyl]benzene, 1,2-bis[(3-ethyl-3-oxetanylmethoxy)methyl]ethane, 1,3-bis[(3-ethyl-3-oxetanylmethoxy)methyl]propane, ethylene glycol bis(3-ethyl-3-oxetanylmethyl) ether, dicyclopentenylbis(3-ethyl-3-oxetanylmethyl) ether, triethylene glycol bis(3-ethyl-3-oxetanylmethyl) ether, tetraethylene glycol bis(3-ethyl-3-oxetanylmethyl) ether, tricyclodecanediyldimethylene(3-ethyl-3-oxetanylmethyl) ether, trimethylolpropane tris(3-ethyl-3-oxetanylmethyl) ether, 1,4-bis(3-ethyl-3-oxetanylmethoxy)butane, 1,6-bis(3-ethyl-3-oxetanylmethoxy)hexane, pentaerythritol tris(3-ethyl-3-oxetanylmethyl) ether, pentaerythritol tetrakis(3-ethyl-3-oxetanylmethyl) ether, polyethylene glycol bis(3-ethyl-3-oxetanylmethyl) ether, dipentaerythritol hexakis(3-ethyl-3-oxetanylmethyl) ether, dipentaerythritol pentakis(3-ethyl-3-oxetanylmethyl) ether, dipentaerythritoltetrakis(3-ethyl-3-oxetanylmethyl) ether, caprolactone-modified dipentaerythritol hexakis(3-ethyl-3-oxetanylmethyl) ether, caprolactone-modified dipentaerythritol pentakis(3-ethyl-3-oxetanylmethyl) ether, ditrimethylolpropane tetrakis(3-ethyl-3-oxetanylmethyl) ether, EO-modified bisphenol A bis(3-ethyl-3-oxetanylmethyl) ether, PO-modified bisphenol A bis(3-ethyl-3-oxetanylmethyl) ether, EO-modified hydrogenated bisphenol A bis(3-ethyl-3-oxetanylmethyl) ether, PO-modified hydrogenated bisphenol A bis(3-ethyl-3-oxetanylmethyl) ether, EO-modified bisphenol F(3-ethyl-3-oxetanylmethyl) ether, and other such polyfunctional oxetanes.

These cationically polymerizable compounds may be employed singly, or two or more may be used concomitantly.

The total mass of the polymerizable compound in the ink is preferably 55 to 95 mass %, more preferably 60 to 90 mass %, with respect to the total mass of the ink. Within the aforedescribed ranges, curability is excellent, and viscosity is appropriate.

The method of manufacturing the polymerizable compound is not particularly limited, and a known method may be employed for synthesis. A commercial product may be used, in cases where procurable.

### (c) Colorants

The ink can contain a colorant in order to improve the visibility of formed image portions.

While the coloring agent is not particularly limited, pigments and oil-soluble dyes, which have excellent weather resistance and rich color reproduction, are preferred, and these may be selected from any of the known coloring agents, such as the soluble dyes. From the standpoint of avoiding depression of the sensitivity of the curing reaction induced by activating radiation, the coloring agents that are suitable for use in the ink are preferably selected from among compounds that do not function as a polymerization inhibitor in polymerization reactions, of which the curing reaction is one.

The pigment is not particularly limited, and organic and inorganic pigments disclosed in the Color Index and having the numbers indicated below may be used, for example.

According to the intended application, there may be used:

Red or magenta pigments: Pigment Red 3, 5, 19, 22, 31, 38, 42, 43, 48:1, 48:2, 48:3, 48:4, 48:5, 49:1, 53:1, 57:1, 57:2, 58:4, 63:1, 81, 81:1, 81:2, 81:3, 81:4, 88, 104, 108, 112, 122, 123, 144, 146, 149, 166, 168, 169, 170, 177, 178, 179, 184, 185, 208, 216, 226, or 257; Pigment Violet 3, 19, 23, 29, 30, 37, 50, 88; Pigment Orange 13, 16, 20, or 36

Blue or cyan pigments: Pigment Blue 1, 15, 15:1, 15:2, 15:3, 15:4, 15:6, 16, 17-1, 22, 27, 28, 29, 36, 60

Green pigments: Pigment Green 7, 26, 36, 50

Yellow pigments: Pigment Yellow 1, 3, 12, 13, 14, 17, 34, 35, 37, 55, 74, 81, 83, 93, 94, 95, 97, 108, 109, 110, 120, 137, 138, 139, 153, 154, 155, 157, 166, 167, 168, 180, 185, 193

Black pigments: Pigment Black 7, 28, 26

White pigments: Pigment White 6, 18, or 21

In preferred practice, the colorant is added to the ink or the inkjet recording ink, and thereafter dispersed to an appropriate degree within the ink. For dispersion of the colorant, for example, any of various dispersion machines such as a ball mill, a sand mill, an attritor, a roll mill, an agitator, a Henschel mixer, a colloidal mill, an ultrasonic homogenizer, a pearl mill, a wet jet mill, a paint shaker, or the like may be used.

During preparation of the ink, the colorant may be incorporated through direct addition together with the other components; however, in order to improve dispersibility, the colorant may be added beforehand to a solvent or a dispersing medium such as a radically polymerizable compound; uniformly dispersed or dissolved therein; and then incorporated.

### (d) Dispersants

In preferred practice, the ink will contain a dispersant in order to stably disperse the pigment within the ink.

A polymeric dispersant is preferable as the dispersant. “Polymeric dispersant” refers to a dispersant having a mass-average molecular weight of 1,000 or above.

As polymeric dispersants, there may be cited polymeric dispersants such as DisperBYK-101, DisperBYK-102, DisperBYK-103, DisperBYK-106, DisperBYK-111, DisperBYK-161, DisperBYK-162, DisperBYK-163, DisperBYK-164, DisperBYK-166, DisperBYK-167, DisperBYK-168, DisperBYK-170, DisperBYK-171, DisperBYK-174, and DisperBYK-182 (all manufactured by BYK Chemie); EFKA4010, EFKA4046, EFKA4080, EFKA5010, EFKA5207, EFKA5244, EFKA6745, EFKA6750, EFKA7414, EFKA745, EFKA7462, EFKA7500, EFKA7570, EFKA7575, and EFKA7580 (all manufactured by EFKA Additives); Disperse Aid 6, Disperse Aid 8, Disperse Aid 15, and Disperse Aid 9100 (manufactured by San Nopco Limited); as well as various types of Solsperse dispersants such as Solsperse 3000, 5000, 9000, 12000, 13240, 13940, 17000, 22000, 24000, 26000, 28000, 32000, 36000, 39000, 41000, and 71000 (manufactured by Avecia); Adeka Pluronic L31, F38, L42, L44, L61, L64, F68, L72, P95, F77, P84, F87, P94, L101, P103, F108, L121, and P-123 (manufactured by Adeka Corporation; Isonet S-20 (manufactured by Sanyo Chemical Industries, Ltd.), and Disparlon KS-860, 873SN, and 874 (polymeric dispersants), #2150 (aliphatic poly carboxylic acid), and #7004 (polyether ester type), manufactured by Kusumoto Chemicals, Ltd.

The content of the respective dispersant in the ink composition is appropriately selected according to the intended purpose, but is preferably 0.05 to 15 mass %, with respect to the mass of the entire ink.

### (e) Other components

Optionally, other components besides the aforedescribed components can be added to the ink.

Examples of these other components include sensitizers, co-sensitizers, surfactants, ultraviolet absorbers, antioxidants, anti-fading agents, conductive salts, solvents, polymer compounds, and basic compounds.

Optionally, besides these, leveling additives, matting agents, waxes for adjusting film physical properties, and tackifiers that do not inhibit polymerization, employed in order to improve adhesion to a support of polyolefin, PET, or the like, can be contained.

A specific examples of tackifiers, there can be given the high molecular weight tacky polymers described on pp. 5 and 6 of JP-A-2001-49200 (e.g. a copolymer formed from an ester of (meth)acrylic acid and an alcohol having an alkyl group with 1 to 20 carbons, an ester of (meth)acrylic acid and an alicyclic alcohol having 3 to 14 carbons, or an ester of (meth)acrylic acid and an aromatic alcohol having 6 to 14 carbons), or low molecular weight tackifying resins having a polymerizable unsaturated bond.

Next, the printing device employed to manufacture the printed article 1 is described.

### Printing Device

As shown in FIG. 2, a printing device (printed article manufacturing device) 1 is adapted to eject a radiation curing ink onto a base material 30, and to then irradiate the ejected radiation curing ink with radiation to bring about curing of the radiation curing ink, and draw alphanumeric characters, pictures, or the like on the base material 30.

The printing device la is constituted by being equipped with a base 2 on which the base material 30 rests; a conveying device 3 for conveying the base material 30 in the X direction in FIG. 2 over the base 2; liquid drop ejection heads (not shown) for ejecting the radiation curing ink; a carriage 4 provided with the plurality of liquid drop ejection heads; and a feed device 5 for transporting the carriage in a Y direction orthogonal to the X direction. In the present embodiment, the conveying device 3 and the feed device 5 constitute a transport device for transporting the base material 30 and carriage 4 in a relative manner in the X direction and Y direction, respectively.

The conveying device 3 is constituted by being provided with a work stage 6 and a stage transport device 7 provided on the base 2. The work stage 6 is provided in transportable fashion in the X direction over the base 2 by the stage transport device 7; and utilizing, for example, a vacuum suction device, is adapted to retain on an XY plane the base material 30 which is conveyed from a conveying device (not shown) disposed to the upstream side from the printing device 1a during the printing process. The stage transport device 7 is provided with a ball and screw, linear guide, or other bearing mechanism; and is constituted such that the work stage 6 is transported in the X direction based on a stage position control signal input from a control device 8 and showing X coordinates of the work stage 6.

As shown in FIGS. 3 and 4, the carriage 4 is a rectangular plate transportably attached to the feed device 5, and is adapted to retain a plurality (ten in the present embodiment) of liquid drop ejection heads (film forming devices) 9 arrayed along the Y direction to the bottom face 4a side thereof.

The plurality of liquid drop ejection heads 9 (9Y, 9C, 9M, 9K, 9W) are provided with a multitude (plurality) of nozzles, to be discussed later, and are adapted to eject liquid drops of radiation curing ink based on drawing data and a drive control signal input from the control device 8. These liquid drop ejection heads 9 (9Y, 9C, 9M, 9K, 9W) respectively eject radiation curing inks corresponding to Y (yellow), C (cyan), M (magenta), and K (black), as well as a radiation curing ink corresponding to a transparent color or white (W). As shown in FIG. 2, tubes (conduits) 10 are linked to the respective liquid drop ejection heads 9 via the carriage 4. Of these ten liquid drop ejection heads 9, the five liquid drop ejection heads 9 to the left side from the middle in FIG. 3 are employed for ejecting liquid drops of the first ink, and the five liquid drop ejection heads 9 to the right side from the middle in FIG. 3 are employed for ejecting liquid drops of the second ink. In manufacture of the printed article 1, the first ink is used whereas the second ink is not used, and therefore the five liquid drop ejection heads 9 to the left side from the middle in FIG. 3 are employed; however, where the five liquid drop ejection heads 9 to the right side from the middle in FIG. 3 are employed, ink drops of the second ink can be ejected to form a printed layer as well.

The liquid drop ejection head 9Y corresponding to Y (yellow) is connected via a tube 10 to a first tank 11 Y filled with or storing Y (yellow) radiation curing ink, whereby Y (yellow) radiation curing ink may be supplied to the liquid drop ejection head 9Y from this first tank 11Y.

Likewise, a second tank 11 C filled with C (cyan) radiation curing ink is connected to the liquid drop ejection head 9C corresponding to C (cyan); a third tank 11M filled with M (magenta) radiation curing ink to the liquid drop ejection head 9M corresponding to M (magenta); a fourth tank 11K filled with K (black) radiation curing ink to the liquid drop ejection head 9K corresponding to K (black); and a fifth tank 11W filled with W (transparent) radiation curing ink to the liquid drop ejection head 9W corresponding to W (transparent or white, in this case, transparent), respectively.

Through this configuration, the liquid drop ejection heads are supplied with the corresponding radiation curing inks.

These liquid drop ejection heads 9Y, 9C, 9M, 9K, 9W, the tubes (conduits) 10, and the tanks 11Y, 11C, 11M, 11K, 11W are provided with heating means such as heaters (not shown) for the respective systems of each color (Y, C, M, K, W). Specifically, in each of the respective color systems, at least one of the liquid drop ejection head 9, the tube 10, and the tank 11 is provided with heating means for depressing the viscosity of the radiation curing ink and increasing the flowability thereof, whereby the radiation curing ink is adjusted to give good ejectability from the liquid drop ejection head 9.

Here, as mentioned previously, the radiation curing ink is of a type that cures upon receiving radiation of a predetermined wavelength, such as an ultraviolet curing ink, for example. Normally, the wavelength bands of radiation (ultraviolet) absorbed by radiation curing inks differ according to the components (formulation) thereof, and therefore the optimal wavelength value for curing, specifically, the optimal curing wavelength, will differ for each ink.

FIG. 5 is a schematic configuration view of a liquid drop ejection head 9. FIG. 5A is a plan view of the liquid drop ejection head 9 viewed from the work stage 6 side; FIG. 5B is a fragmentary perspective view of the liquid drop ejection head; and FIG. 5C is a fragmentary sectional view of one nozzle of the liquid drop ejection head 9.

As shown in FIG. 5A, the liquid drop ejection head 9 has a plurality (for example, 180) nozzles N which are arrayed in a direction intersecting the Y direction; in the present embodiment, this is the X direction. The plurality of nozzles N form a nozzle array NA. While only the nozzles of a single array are shown in the drawing, the number of nozzles and the number of nozzle arrays provided to the liquid drop ejection head 9 may be freely modified, and a plurality of nozzle arrays NA arrayed in the X direction could be provided in the Y direction, for example.

As shown in FIG. 5B, the configuration is provided with an oscillator plate 20 provided with a material supply port 20a that is linked to a tube 10; a nozzle plate 21 provided with nozzles N; a reservoir (liquid reserve) 22 provided between the oscillator plate 20 and the nozzle plate 21; a plurality of partition walls 23; and a plurality of cavities (liquid chambers) 24. The front face (bottom face) of the nozzle plate 21 serves as a nozzle surface 21a in which the plurality of nozzles N are formed. Piezoelectric elements (driving elements) PZ are disposed, in corresponding fashion with the nozzles N, on the oscillator plate 20. The piezoelectric elements PZ are composed of piezo elements, for example.

The reservoir 22 is filled with radiation curing ink which is supplied via the material supply port 20a. The cavities 24 are formed in such a way as to be bounded by the oscillator plate 20, the nozzle plate 21, and pairs of partition walls 23, and are provided on a one-to-one basis in corresponding fashion with the nozzles N. Radiation curing ink from the reservoir 22 is introduced into the cavities 24 via a supply opening 24a provided between the pair of partition walls 23.

As shown in FIG. 5C, the piezoelectric element PZ has a piezoelectric material 25 sandwiched by a pair of electrodes 26, and is configured such that the piezoelectric material 25 constricts upon application of a drive signal to the pair of electrodes 26. Consequently, the oscillator plate 20 on which the piezoelectric element PZ is disposed simultaneously flexes towards the outside (towards the opposite side from the cavity 24) in unison with the piezoelectric element PZ, thereby increasing the volume of the cavity 24.

The radiation curing ink, in an amount commensurate with the increased volume of the cavity 24, thereby flows in from the liquid reserve 22 via the supply opening 24a. From this state, once the drive signal ceases to be applied to the piezoelectric element PZ, the piezoelectric element PZ and the oscillator plate 20 both recover to their original shapes, and the cavity 24 recovers to its original volume. Therefore, the pressure of the radiation curing ink inside the cavity 24 rises, and a drop L of radiation curing ink is ejected towards the base material 30 from the nozzle N.

Liquid drop ejection heads 9 constituted in this manner are disposed with the bottom face of the nozzle plate 21 thereof, specifically, the nozzle N formation surface (nozzle surface) NS, protruding from the bottom face 4a of the carriage 4, further towards the bottom from the bottom face of the carriage 4 as shown in FIG. 3.

Additionally, as shown in FIGS. 3 and 4, radiation irradiating means 12 are disposed adjacently to either side of the plurality of arrayed liquid drop ejection heads 9 (there are ten in the drawing) on the carriage 4. Specifically, the radiation irradiating means 12 are respectively disposed to either side of the liquid drop ejection heads 9 which are arrayed in the Y direction, along the direction of array.

These radiation irradiating means 12 are adapted to bring about curing of the radiation curing ink, and in the present embodiment are composed of a multitude of light-emitting diodes (LEDs). However, the radiation irradiating means 12 in the present invention are not limited to LEDs, provided that they are capable of shooting out radiation of a wavelength that precipitates polymerization of the radiation curing ink; besides LEDs, for example, laser diodes (LD), mercury lamps, metal halide lamps, xenon lamps, excimer lamps, and the like may be employed as the radiation irradiating means 12. For example, in a case in which an ultraviolet curing ink is employed as the radiation curing ink, various light sources that shoot out ultraviolet could be used.

The radiation irradiated by the LED radiation irradiating means 12 of the present embodiment has a wavelength band that includes the optimal curing wavelength of the radiation curing ink ejected by the liquid drop ejection heads 9. That is, as mentioned previously, whereas the optimal curing wavelengths of radiation curing inks are assumed to differ according to the components (formulation) thereof, radiation having the optimal curing wavelength of a radiation curing ink may be irradiated through irradiation of radiation in the manner discussed above.

As shown in FIG. 2, the feed device 5 that transports the carriage 4 has, for example, a bridge structure that spans the base 2, and is provided with a with a ball and screw, linear guide, or other bearing mechanism with respect to the Y direction and a Z direction orthogonal to the XY plane. The feed device 5 constituted in this manner is adapted to transport the carriage 4 in the Y direction, as well as transport it in the Z direction, on the basis of a carriage positioning signal input from the control device 8, and showing Y coordinates and Z coordinates for the carriage 4.

The control device 8 is adapted to output a stage positioning signal to the stage transport device 7, and to output the carriage positioning signal to the feed device 5, as well as to output drawing data and drive control signals to the drive circuit boards (not shown) of the liquid drop ejection heads 9. The control device 8 thereby performs synchronous control of an operation to position the base material 30 through transport thereof by the work stage 6, and an operation to position the liquid drop ejection heads 9 through transport thereof by the carriage 4, whereby the base material 30 and the carriage 4 are transported in a relative manner; and to then perform an operation to eject liquid drops from the liquid drop ejection heads 9, whereby drops of the radiation curing ink are distributed at predetermined positions on the base material 30. Additionally, separately from the operation to eject liquid drops from the liquid drop ejection heads 9, the control device 8 also performs an operation to irradiate radiation from the radiation irradiating means 12.

The configuration of the printing device 1 a is as described above.

Next, the printed article 1 will be described.

As shown in FIGS. 1 and 2, the printed article 1 has a base material 30, and a light-blocking layer 31 and a light-blocking remediation layer 32 which are provided directly or indirectly to the base material 30.

In the present embodiment, the printed article 1 is intended to be viewed from the opposite side thereof from the base material 30, i.e., from the light-blocking layer 31 side. The printed article 1 is provided with the base material 30; the light-blocking layer 31, which is provided on one side of the base material 30; and the light-blocking remediation layer 32, which has light-blocking ability and which is provided to the back surface of the base material 30 as seen from the direction in which the printed article 1 is intended to be viewed. Specifically, with respect to the direction in which the printed article 1 is intended to be viewed, the light-blocking layer 31 is provided to the front surface side of the base material 30, whereas the light-blocking remediation layer 32 is provided to the back surface side of the base material 30. Expressed another way, it can be said that the light-blocking layer 31 is provided to one side of the base material 30, which is the side thereof from which the printed article 1 is intended to be viewed; while the light-blocking remediation layer 32 is provided to the other side of the base material 30, which is the opposite side from the side thereof from which the printed article 1 is intended to be viewed.

Additionally, the printed article 1 has a deformed section 41 in which the base material 30 is stretched by a deforming process, and the light-blocking remediation layer 32 is provided in a region which includes the deformed section 41. Consequently, the light-blocking remediation layer 32 is provided in a region of overlap of the deformed section 41 and the light-blocking layer 31, as seen from the side from which the printed article 1 is intended to be viewed.

Furnishing the light-blocking remediation layer 32 has the effect of ensuring sufficient light-blocking ability, without increasing the overall thickness of the light-blocking layer 31, and without forming asperity on the surface, as seen in the direction in which the printed article 1 is intended to be viewed.

Specifically, in a case in which the printed article 1 shown in FIG. lA has been subjected to a deforming process to manufacture the printed article 1 shown in FIG. 1B, if the deformed section 41 has been stretched, for example, two-fold, the thickness of the light-blocking layer 31 and the light-blocking remediation layer 32 will be reduced to one-half. Consequently, if the light-blocking remediation layer 32 were not provided, light-blocking ability would be insufficient; in this printed article 1, however, the reduction in the light-blocking ability of the light-blocking layer 31 can be compensated by the light-blocking remediation layer 32, and sufficient light-blocking ability can be ensured. Additionally, because the light-blocking remediation layer 32 is provided to the back surface side of the base material 30 as seen from the direction in which the printed article 1 is intended to be viewed, a printed article 1 free from asperity on the surface can be attained. Expressed another way, the printed article 1 shown in FIG. 1B can be referred to as a molded article obtained by performing a deformation process on the printed article 1 shown in FIG. 1A.

The color of the light-blocking layer 31 is not particularly limited, but is preferably black. Because the light-blocking remediation layer 32 is positioned on the back surface side of the light-blocking layer 31 as seen from the direction in which the printed article 1 is intended to be viewed, the color of the light-blocking remediation layer 32 is not particularly limited. Therefore, it is not necessary for the color of the light-blocking remediation layer 32 to be the same as that of the light-blocking layer 31, thus affording greater latitude in design. However, the color of the light-blocking remediation layer 32 is preferably black as well.

As mentioned previously, the first ink is employed respectively as the ink for forming the light-blocking layer, which is employed to form the light-blocking layer 31, and as the ink for forming the light-blocking remediation layer, which is employed to form the light-blocking remediation layer 32; however, the ink for forming the light-blocking layer and the ink for forming the light-blocking remediation layer can be either the same or different.

In a case in which the ink employed for forming the light-blocking remediation layer is different from the ink for forming the light-blocking layer, it is preferable for the light-blocking remediation layer 32 formed thereby to have a reinforcing function. For example, it is preferable for the light-blocking remediation layer 32 to be able to retain sufficient light-blocking ability even when the printed article 1 has been bent as shown in FIG. 1B. Specifically, the light-blocking remediation layer 32 preferably has a higher elastic modulus and a higher viscoelastic modulus than the light-blocking layer 31.

The constituent material of the base material 30 is not particularly limited, provided that it is amenable to deformation processes. Various resins such as the following can be employed, for example.

The resin materials are not particularly limited, and, for example, polyethylene, polypropylene, ethylene-propylene copolymers, ethylene-vinyl acetate copolymers (EVA), and other polyolefins; cyclic polyolefins, modified polyolefins, polyvinyl chloride, polyvinylidene chloride, polystyrene, polyamide, polyimide, polyamide-imide, polycarbonate, poly-(4-methylpentene-1), ionomers, acrylic resins, polymethyl methacrylate, acrylonitrile-butadiene-styrene copolymers (ABS resins), acrylonitrile-styrene copolymers (AS resins), butadiene-styrene copolymers, polyoxymethylene, polyvinyl alcohol (PVA), ethylene-vinyl alcohol copolymers (EVOH); polyethylene terephthalate (PET), polybutylene terephthate (PBT), polycyclohexane terephthate (PCT) and other polyesters; polyether, polyether ketone (PEK), polyether ether ketone (PEEK), polyether imide, polyacetal (POM), polyphenylene oxide, modified polyphenylene oxide, polysulfone, polyether sulfone, polyphenylene sulfide, polyarylate, aromatic polyesters (liquid crystal polymers), and the like, or copolymers, blends, or polymer alloys composed predominantly thereof, may be cited. These may be employed singly, or in combinations of two or more (for example, in a laminate of two or more layers).

In the present embodiment, the light-blocking layer 31 may be constituted, for example, to include a prescribed pattern in which the light-blocking layer 31 is not formed, and by furnishing a backlight of the like on the opposite side thereof from the direction in which the printed article 1 is intended to be viewed, to make the predetermined pattern visible. For this reason, a transparent constituent material is employed for the base material 30.

The printed article 1 prior to processing shown in FIG. 1A has a deformed section 41 stretched through a deforming process. Specifically, the printed article 1 subsequent to processing shown in FIG. 1B has a stretched deformed section 41 produced by a deforming process. Both the printed article 1 prior to processing shown in FIG. lA and the printed article 1 subsequent to processing shown in FIG. 1B are included in the printed article of the present invention.

As the deforming process, there may be cited processes involving localized stretching, such as a drawing process, a bending process, or the like. In the illustrated configuration, the printed article 1 has been subjected to bending and stretching by a drawing process.

The light-blocking layer 31 and the light-blocking remediation layer 32 are respectively formed by printing. In the present embodiment, the light-blocking layer 31 and the light-blocking remediation layer 32 are respectively formed through application (coating) with ink by an inkjet method employing the printing device 1a. Specifically, the light-blocking layer 31 is produced by supplying the first ink, i.e., the ink for forming the light-blocking layer, by ejecting liquid drops thereof from nozzles N by an inkjet method, followed by curing through irradiation with radiation. The light-blocking remediation layer 32 is produced by applying the first ink, i.e., the ink for forming the light-blocking remediation layer, by ejecting liquid drops thereof from nozzles N by an inkjet method, followed by curing through irradiation with radiation.

The printed article 1 is not particularly limited, and as examples there may be cited interior components for cars, such as a speedometer or the like; exterior components for electronic devices; masks; signage; and the like.

Next, the method of manufacturing the printed article 1 is described.

The printing device la is employed for manufacturing the printed article 1.

First, the base material 30 is rested on the work stage 6 as shown in FIG. 2.

Next, the printing device la is operated to eject and apply the ink for forming the light-blocking remediation layer onto the region in which the light-blocking layer 31 is to be formed on the base material 30. The applied ink for forming the light-blocking remediation layer is then irradiated with radiation by the radiation irradiating means 12 to bring about curing and form the light-blocking layer 31.

Next, the base material is reversed, and thereafter the printing device la is operated to eject and apply the ink for forming the light-blocking remediation layer onto the region in which the light-blocking remediation layer 32 is to be formed on the base material 30. The applied ink for forming the light-blocking remediation layer is then irradiated with radiation by the radiation irradiating means 12 to bring about curing and form the light-blocking remediation layer 32. Of course, the light-blocking remediation layer 32 could be formed first instead.

Next, the deforming process is performed on the printed article 1 to form the deformed section 41. This drawing process is performed under heating.

As described above, according to this printed article 1, by furnishing the light-blocking remediation layer 32, ample light-blocking ability can be ensured without increasing the thickness of the light-blocking layer 31 as a whole, and without forming asperity on the surface as seen from the direction in which the printed article 1 is intended to be viewed.

### Second Embodiment

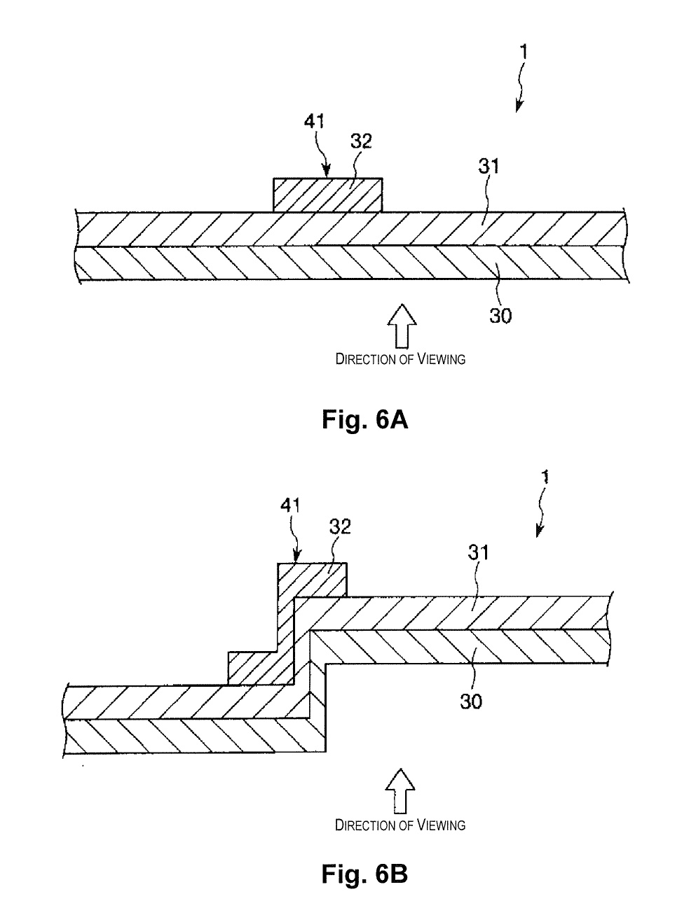

FIGS. 6A and 6B are cross sectional views showing a second embodiment of the printed article of the present invention. In the following description, the left side in FIG. 6 shall be designated as “left,” the right side as “right,” the top side as “top,” and the bottom side as “bottom.”

The description of the second embodiment shall focus on points of difference from the first embodiment discussed previously, omitting description of comparable arrangements.

As shown in FIG. 6, the printed article 1 of the second embodiment is provided with a light-blocking layer 31 situated on the back face side of the base material 30 as seen from the direction in which the printed article 1 is intended to be viewed, and with a light-blocking remediation layer 32 situated on the back face side of the light-blocking layer 31. Expressed another way, it can be said that the light-blocking layer 31 is provided to the other side of the base material 30 which is the opposite side from that from which the printed article 1 is intended to be viewed, and the light-blocking remediation layer 32 is provided to the other side of the light-blocking layer 31 which is the opposite side from that from which the printed article 1 is intended to be viewed. In so doing, the light-blocking remediation layer 32 is positioned on the back face side of the light-blocking layer 31 as seen from the direction in which the printed article 1 is intended to be viewed, and therefore the color of the light-blocking remediation layer 32 need not be same as that of the light-blocking layer 31, thus affording greater latitude in design.

Additionally, because the light-blocking layer 31 and the light-blocking remediation layer 32 are positioned on the same side with respect to the base material 30, the light-blocking layer 31 and the light-blocking remediation layer 32 can be formed without flipping the base material 30.

### Third Embodiment

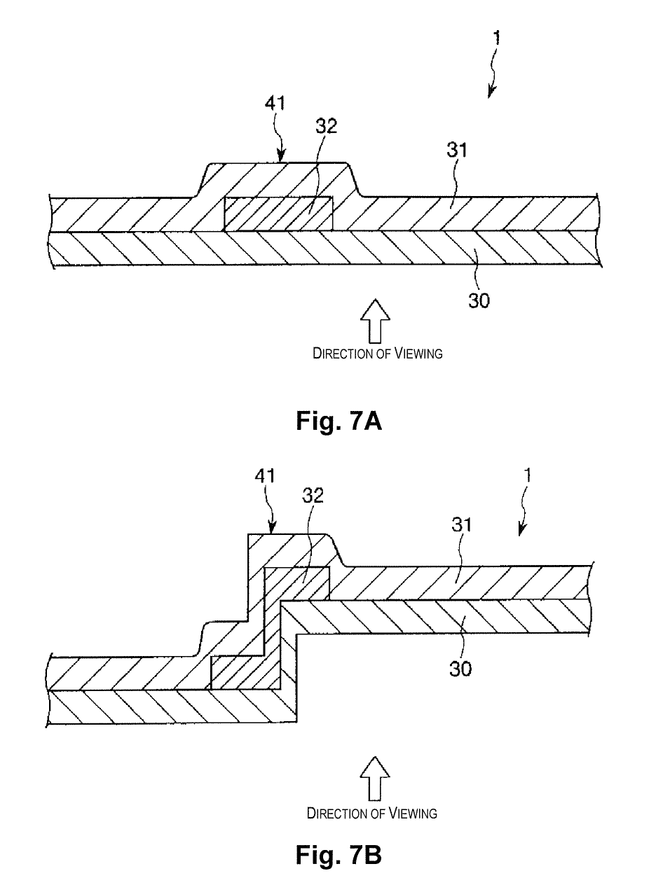

FIGS. 7A and 7B are cross sectional views showing a third embodiment of the printed article of the present invention. In the following description, the left side in FIG. 7 shall be designated as “left,” the right side as “right,” the top side as “top,” and the bottom side as “bottom.”

The description of the third embodiment shall focus on points of difference from the first embodiment discussed previously, omitting description of comparable arrangements.

As shown in FIG. 7, the printed article 1 of the third embodiment is provided with a light-blocking remediation layer 32 situated on the back face side of the base material 30 as seen from the direction in which the printed article 1 is intended to be viewed, and a light-blocking layer 31 provided so as to cover the light-blocking remediation layer 32, as seen from the opposite direction from the direction in which the printed article 1 is intended to be viewed. Expressed another way, it can be said that the light-blocking remediation layer 32 is provided to the other side of the base material 30 which is the opposite side from that from which the printed article 1 is intended to be viewed, and the light-blocking layer 31 is provided to the other side of the light-blocking remediation layer 32 which is the opposite side from that from which the printed article 1 is intended to be viewed. The light-blocking layer 31 and the light-blocking remediation layer 32 are positioned on the same side of the base material 30. Therefore, the light-blocking layer 31 and the light-blocking remediation layer 32 can be formed without flipping the base material 30.

While the printed article and the method of manufacturing a printed article of the present invention have been described on the basis of the illustrated embodiments, the present invention is not limited thereto, and the configurations of various parts may be replaced by any configurations having equivalent functions. Other additional configurations and steps may be incorporated to the present invention as well.

The present invention may combine any two or more configurations (features) among those taught in the preceding embodiments.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A molded article obtained by carrying out a deforming process on a printed article including a base material, a light-blocking layer having light-blocking ability disposed on one side of the base material from which the molded article is intended to be viewed or on the other side of the base material opposite from the one side, and a light-blocking remediation layer having light-blocking ability disposed on the other side of the base material, the molded article comprising:
a deformed section in which the base material has been stretched by carrying out the deforming process on the printed article, and
the light-blocking remediation layer being provided in a region of overlap of the deformed section and the light-blocking layer, when seen from the one side of the base material from which the molded article is intended to be viewed.

2. The molded article according to claim 1, wherein
the light-blocking layer is provided to the one side of the base material.

3. The molded article according to claim 1, wherein
the light-blocking layer is provided to the other side of the base material, and
the light-blocking remediation layer is provided to the other side of the light-blocking layer opposite from the side from which the molded article is intended to be viewed.

4. The molded article according to claim 1, wherein
the light-blocking remediation layer is provided to the other side of the base material, and
the light-blocking layer is provided to the other side of the light-blocking remediation layer opposite from the side from which the molded article is intended to be viewed.

5. The molded article according to claim 1, wherein
the light-blocking layer and the light-blocking remediation layer are positioned on the same side with respect to the base material.

6. The molded article according to claim 1, wherein
the light-blocking layer is formed by ink for forming the light-blocking layer supplied by ejection of liquid drops from nozzles by an inkjet method, and
the light-blocking remediation layer is formed by ink for forming the light-blocking remediation layer supplied by ejection of liquid drops from nozzles by an inkjet method.

7. The molded article according to claim 1, wherein
an ink for forming the light-blocking layer and an ink for forming the light-blocking remediation layer are radiation curing inks,
the light-blocking layer is a layer in which the ink for forming the light-blocking layer is supplied by ejection of liquid drops from nozzles by an inkjet method and then cured by irradiation with radiation, and
the light-blocking remediation layer is a layer in which the ink for forming the
light-blocking remediation layer is supplied by ejection of liquid drops from nozzles by an inkjet method and then cured by irradiation with radiation.

8. A printed article adapted to be deformed to form a molded article, comprising:
a base material;
a light-blocking layer having light-blocking ability disposed on one side of the base material from which the molded article is intended to be viewed or on the other side of the base material opposite from the one side; and
a light-blocking remediation layer having light-blocking ability disposed on the other side of the base material,
the light-blocking remediation layer being provided in a region of overlap of a deformed section, in which the base material is to be stretched by carrying out a deforming process on the printed article, when seen from the one side of the base material from which the molded article is intended to be viewed.

9. A method of manufacturing a molded article comprising:
forming the printed article; and
carrying out the deforming process on the printed article,
the forming of the printed article including
forming a light-blocking layer having light-blocking ability on one side of a base material or on the other side of the base material, and
forming a light-blocking remediation layer having light-blocking ability in a region on the other side of the base material so that the light-blocking layer and a deformed section constituted by a region in which the base material is stretched by carrying out the deforming process overlap when seen from the side from which the printed article is intended to be viewed.

10. A method of manufacturing a printed article comprising
forming a light-blocking layer having light-blocking ability on one side of a base material or on the other side of the base material; and
forming a light-blocking remediation layer having light-blocking ability in a region on the other side of the base material so that the light-blocking layer and a deformed section constituted by a region in which the base material is stretched by carrying out the deforming process overlap when seen from the side from which the printed article is intended to be viewed.
